(19) United States
(12) Patent Application Publication
(10) Pub. No.: US 2014/0298898 A1
(43) Pub. Date: Oct. 9, 2014

(54) TESTING APPARATUS AND TESTING METHOD

(71) Applicant: Wistron Corporation, New Taipei City (TW)

(72) Inventors: Jun-Min YANG, New Taipei City (TW); Hao-Chun TSAI, New Taipei City (TW); Hsin-Lun TSAI, New Taipei City (TW); Sheng-Wen CHENG, New Taipei City (TW); Chia-Hsien LEE, New Taipei City (TW)

(73) Assignee: Wistron Corporation, New Taipei City (TW)

(21) Appl. No.: 14/033,739

(22) Filed: Sep. 23, 2013

(30) Foreign Application Priority Data
Apr. 3, 2013 (TW) 102112123

(51) Int. Cl. G01B 21/22

(52) U.S. Cl. CPC G01B 21/22
USPC 73/150 R

(57) ABSTRACT

A testing apparatus and a testing method are disclosed. The testing apparatus has a testing assembly. The testing assembly includes a first plate body, a testing paper, and a second plate body. The first plate body has a plurality of pins; the testing paper includes a plurality of first through holes whose locations correspond to the plurality of pins. The second plate body connects with the testing paper and has a plurality of second through holes whose locations correspond to the first through holes for allowing the plurality of pins to pass through the corresponding through holes. A sprayer is located, beneath the second plate body and sprays flux onto the inner wall of each second through hole, and a plurality of wet marks are left on the testing paper for interpretation of the coating quality.

### FIELD

The present invention relates to a testing apparatus and a testing method, and especially relates to a testing apparatus and a testing method for testing the quality of a flux coating.

### BACKGROUND

As technology develops, the functions of electronic products have become more and more complex, and it is also a trend for electronic products to be compact and lightweight. However, in order to accomplish the complex functions of the electronic products, the electronic components within the electronic products have a significant increase in performance, accompanied by a noticeable increase in the quantity of pins. Therefore, the PCB (printed circuit board) layouts of electronic products have become delicate and complicated, and the welding of electronic components on the PCB has become more difficult.

Before electronic components are welded to a PCB, a flux coating procedure sprays flux for removing the oxides on the surface of the PCB to prevent re-oxidation, decrease the surface tension of the solder, and increase the welding performance. Furthermore, the quantity of the flux sprayed on the PCB directly affects the reliability of the welding joint. If the sprayed quantity of flux is inadequate, an insufficient amount of solder will contact the complements accommodated in the penetrating hole. If too much flux is sprayed, built up residues of the acidic flux material will damage the PCB in the long term, causing electrical failure; in addition, overuse of flux causes waste and increases the manufacturing costs accordingly.

Please refer to FIG. 1 to understand the prior art testing assembly 100. As shown in FIG. 1, the prior art testing assembly 100 comprises a PCB 80, a base fixture 90, and a testing paper (not shown), wherein the testing paper is attached on the PCB 80. In FIG. 1, from the viewer's point of view, the stacked position (from the near side to the far side) is the base fixture 90, the PCB 80, and the testing paper. In general, the PCB 80 is a dummy PCB; i.e., it is an actual PCB used in real electronic products, but one without any electronic components welded to it. The plurality of holes 91 of the base fixture 90 are set according to the positions of the components' pins for facilitating flux spraying. While the prior art testing assembly 100 is in a flux testing process, the flux is sprayed underneath the base fixture 90, passes through the through hole of the PCB 80, and leaves wet marks on the testing paper.

After the flux spraying procedure is finished, a technician removes the testing paper from the PCB 80 and observes the wet marks on the testing paper to determine whether every through hole in the PCB 80 has been coated with flux or not. This testing method can identify only whether every through hole in the PCB 80 is coated with flux or not; however, the quality of the spray coating in each through hole cannot be identified. Therefore, after the welding process is accomplished, problems such as poor solder joint reliability or dewetting still occur even if every through hole in the PCB 80 was coated with flux. The cause of the above-mentioned problems is the lack of electronic components placed on the PCB 80 used in the prior art testing assembly 100; during the actual welding process, the pins of electronic components are accommodated in each through hole of the PCB 80, and the pin, being inside the through hole of the PCB 80, occasionally blocks the flux coating, which causes the quality of a flux coating of the through hole to be poor and leads to the problem of poor solder joint reliability or de wetting.

To sum up, because the quality of a flux spray coating has a direct effect on the welding process and the solder joint reliability of the PCB afterwards, there is a need to provide a new testing assembly for testing the quality of a flux spray coating to overcome the problems in the prior art.

### SUMMARY

One object of the present invention is to provide a testing apparatus for testing the quality of a flux coating.

Another object of the present invention is to provide a testing method for testing the quality of a flux coating.

In order to achieve the abovementioned objects, the testing apparatus of the present invention comprises a testing assembly and a base, wherein the base is applied for bearing the testing assembly. The testing assembly comprises a first plate body, a testing paper, and a second plate body. The first plate body comprises a plurality of pins; the testing paper is stacked on the first plate body. The testing paper comprises a plurality of first through holes, each of which corresponds to a pin. The second plate body is stacked on a surface opposite to the surface connected to the testing paper of the first plate body. The second plate body comprises a plurality of second through holes, each of which is corresponding to a first through hole for allowing every pin to pass through the corresponding first through holes and the second through holes. After the flux has been sprayed underneath the second plate body by the sprayer, the testing paper is removed and at least one wet mark corresponding to each second through hole is left on the testing paper for interpretation; thus, the quality of a flux coating of the testing apparatus can he evaluated.

According to one embodiment of the present invention, the second plate body further comprises a first surface opposite to the surface connected to the testing paper, and the plurality of pins are exposed to the first surface after the plurality of pins pass through the plurality of second through holes respectively.

According to one embodiment of the present invention, the plurality of second through holes comprise a plurality of aperture sizes and/or a plurality of formats.

According to one embodiment of the present invention, the base comprises a bearing surface, and the second plate body further comprises a first surface opposite to the. surface connected with the testing paper, wherein the bearing surface contacts the first surface and the bearing surface comprises at least one opening for exposing the plurality of second through holes.

According to one embodiment of the present invention, when the sprayer sprays the flux underneath the base, the flux passes through the opening and is coated on an inner wall of each second through hole, such that at least one wet mark is left on the testing paper corresponding to a location of each of the second through holes for interpretation.

According to one embodiment of the present invention, the base comprises at least one clamp, and the at least one clamp comprises a fixed end and a free end, wherein the fixed end is connected with the bearing surface. When the testing assembly is placed on the base, the free end touches the first plate body for fixing the testing assembly between the bearing surface and the clamp.

According to one embodiment of the present invention, the wet mark is in an annular shape, and the annular shape comprises at least one opening angle θ. The quality of a flux coating is satisfactory when the at least one opening angle θ is equal to or smaller than 60°. The flux-spray coating quality is unsatisfactory when the at least one opening angle θ has a plurality of opening angles θ or the at least one opening angle θ is greater than or equal to 60°.

The present invention further provides a testing method for testing the quality of a flux coating of the testing apparatus after a flux has been sprayed thereon by a sprayer. The testing method comprises the following steps: allowing each pin of the first plate body to pass through each of the first through holes of the testing paper respectively; allowing each of the pins of the first plate body to pass through each of the second through holes of the second plate body respectively; spraying the flux underneath the second plate body by the sprayer; then removing the testing paper and interpreting at least one wet mark corresponding to each second through hole left on the testing paper for evaluating the quality of the flux-spray coating of the testing apparatus.

According to one embodiment of the present invention, the testing method further comprises the following steps before the sprayer sprays the flux beneath the second plate body: placing the testing assembly on the base, and fixing the testing assembly to the bearing surface by the at least one clamp.

According to one embodiment of the present invention, the at least one wet mark is in an annular shape and the testing method for interpreting the at least one wet mark further comprises the following steps: the flux-spray coating quality is satisfactory when the annular shape comprises at least one opening angle θ and the at least one opening angle θ is equal to or smaller than 60°; the flux-spray coating quality is unsatisfactory when the at least one opening angle θ is greater than 60°.

### BRIEF DESCRIPTION OF THE DRAWINGS

The exemplary embodiment of the present invention will be understood more fully from the detailed description given below and from the accompanying drawings of the invention, which, however, should not be taken to limit the invention to the specific embodiment, but are for explanation and understanding only.

FIG. 1 is the prior art of the testing assembly.

FIG. 2 is an exploded view of the testing apparatus of the present invention.

FIG. 3 is a schematic drawing of the testing apparatus of the present invention.

FIG. 4 is a sectional schematic drawing of the present invention.

FIG. 5 is a partly enlarged drawing of FIG. 4.

FIG. 6 is a schematic drawing of the wet marks on the testing paper.

FIG. 7 is a schematic drawing of the opening angle of the wet marks.

FIG. 8 is the flow chart of the testing method of the present invention.

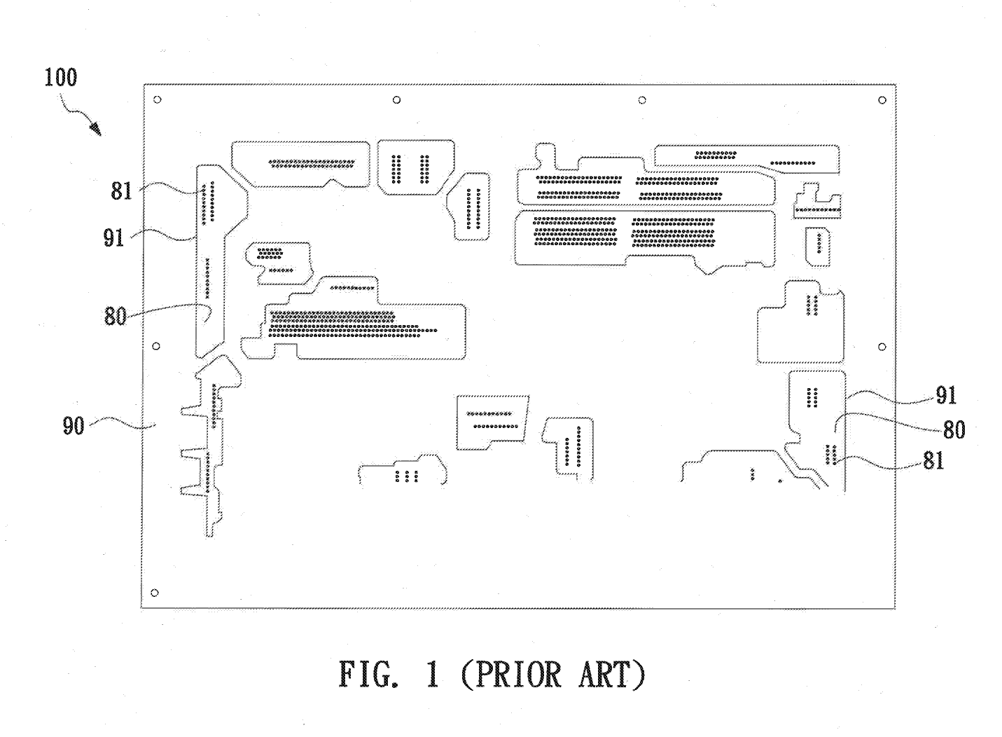

### DETAILED DESCRIPTION

To facilitate understanding and to clarify the object, characteristics and advantages of the present invention, the following specific embodiment and figures illustrating the present invention are presented to provide a detailed description.

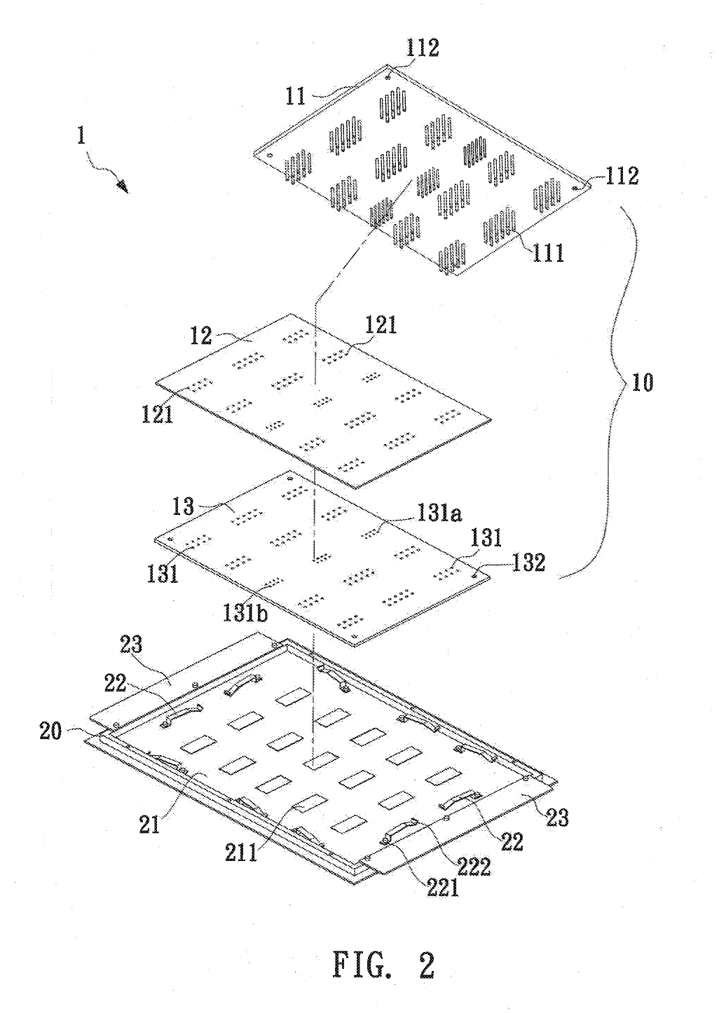

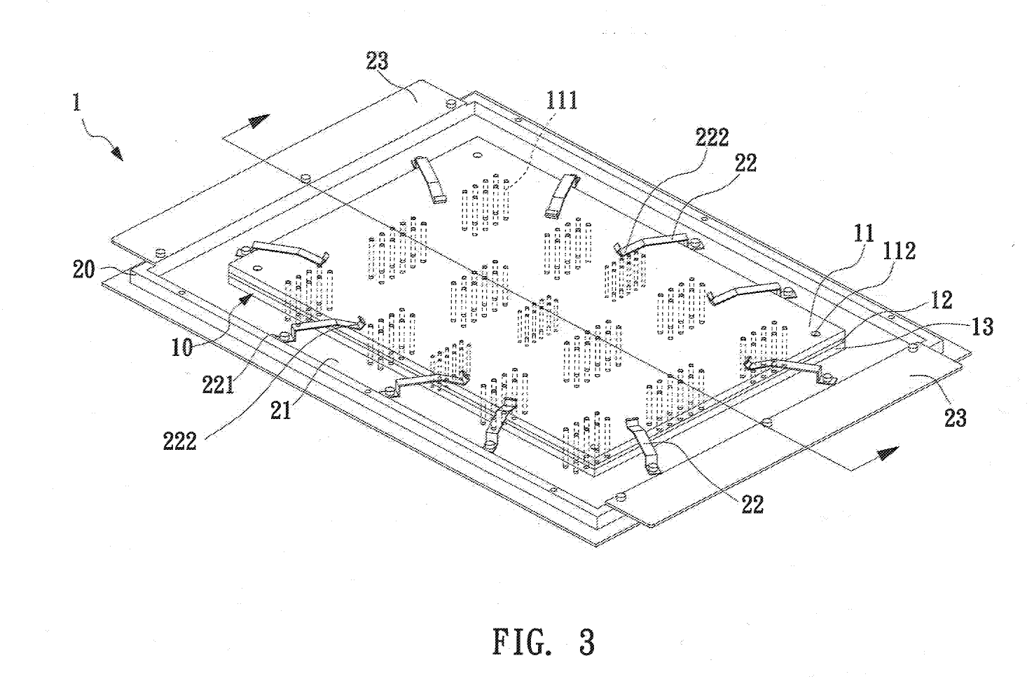

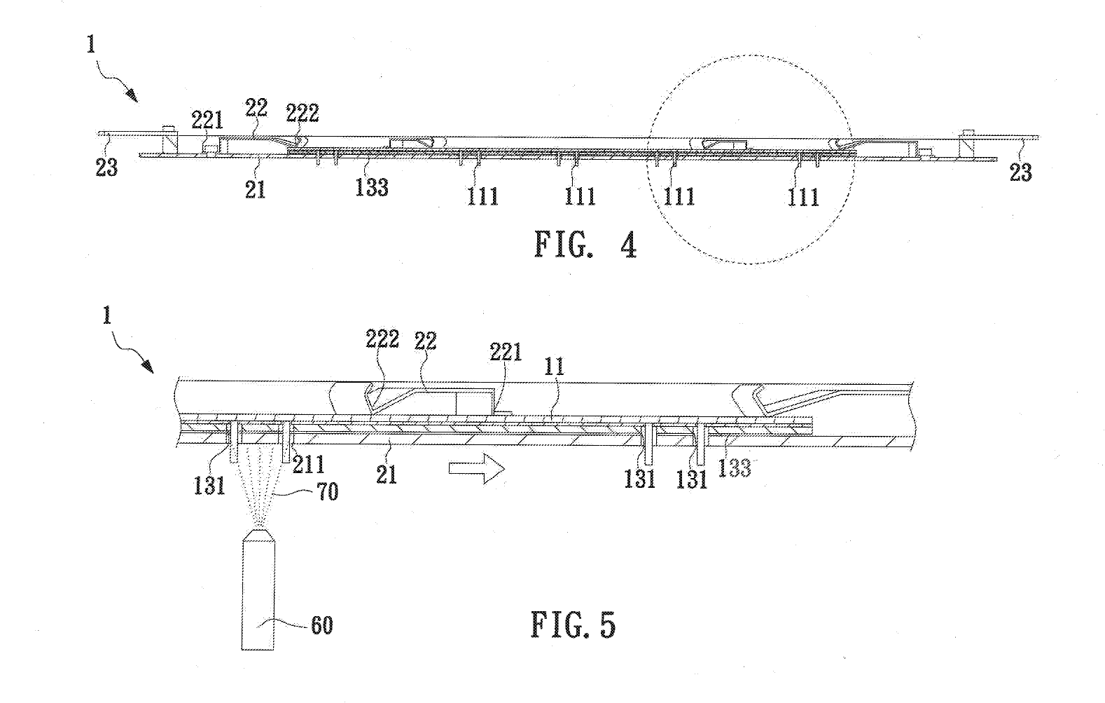

Please refer to FIG. 2 to FIG. 5, relating to one embodiment of the present invention, wherein FIG. 2 is an exploded view of the testing apparatus of the present invention; FIG. 3 is a schematic drawing of the testing apparatus of the present invention; FIG. 4 is a sectional schematic drawing of the present invention; FIG. 5 is a partly enlarged drawing of FIG. 4.

The testing apparatus 1 of the present invention is employed for testing the quality of a flux coating of the testing apparatus 1 after a flux 70 has been sprayed thereon by a sprayer 60. As shown in FIG. 2 and FIG. 3, the testing apparatus 1 of the present invention comprises a testing assembly 10 and a base 20, wherein the base 20 is applied for bearing the testing assembly 10. The testing assembly 10 comprises a first plate body 11, a testing paper 12, and a second plate body 13. The base 20 comprises a bearing surface 21 and at least one clamp 22, wherein the testing assembly 10 is placed on the bearing surface 21 and the testing assembly 10 is fixed between the at least one clamp 22 and the bearing surface 21.

In this embodiment, as shown in FIG. 2 and FIG. 3, the first plate body 11 is a steel plate. The first plate body 11 comprises a plurality of pins 111 and locating holes 112. The plurality of pins 111 simulate the pins of various electronic components mounted in a PCB; therefore, the plurality of pins 111 comprise a plurality of aperture sizes and formats. Furthermore, the locations and arrangement of the plurality of pins 111 can be customized, and the arrangements shown in FIG. 2 and FIG. 3 are for illustration only.

As shown in FIG. 2, the testing paper 12 is stacked on the first plate body 11, and the testing paper 12 has a plurality of first through holes 121, each of which corresponds to a pin 111, for allowing the plurality of pins 111 to pass through. After the plurality of pins ill pass through a plurality of first through holes 121, the testing paper 12 is fixed with the first plate body 11 by an adhesive tape or other proper fastening. In this embodiment, the testing paper 12 is thermal paper; however, the present invention is not limited to this. The testing paper 12 can be replaced with any material that is capable of absorbing flux.

As shown in FIG. 2, the second plate body 13 comprises a plurality of second through holes 131, a locating hole 132, and a first surface 133 at the bottom, wherein the locations of the plurality of second through holes 131 are corresponding to the locations of the plurality of first through holes 121 for allowing each pin 111 to pass through the corresponding second through hole 131. The locating hole 132 is used for aligning with the locating hole 112 of the first plate body 11, such that the plurality of pins 111 can pass through the plurality of second through holes 131 smoothly. The hole-to-hole alignment in this embodiment is one example, but the present invention is not limited to this.

Another example is to dispose a convex post on the base 20 for connecting and aligning with the locating hole 132. The testing paper 12 is clipped in-between the first plate body 11 and the second plate body 13 for accomplishing the assembly of the testing assembly 10 of the present invention. It is noted that the plurality of second through holes 131 of the second plate body 13 is applied for simulating a condition in which the flux 70 is sprayed on various sizes of through holes; therefore, as mentioned before, identical to the pin 111, the second through holes 131 comprise a plurality of aperture sizes and formats. Furthermore, as shown in FIG. 4 and FIG. 5, after the plurality of pins 111 pass through the corresponding second through holes 131, the plurality of pins 111 are exposed to the first surface 133 of the second plate body 13. In this embodiment, the second plate body 13 of the present invention is a dummy for simulating an actual PCB.

As shown in FIG. 2 and FIG. 3, after the testing assembly 10 of the present invention is assembled, the testing assembly 10 can be placed on the base 20 of the present invention. In this embodiment, the first surface 133 of the second plate body 13 in the testing assembly 10 directly contacts the bearing surface 21 of the base 20. As shown in FIG. 5, the bearing surface 21 further comprises at least one opening 211 for exposing the plurality of second through holes 131 to allow the sprayer 60 to spray the flux 70 underneath the base 20. It is noted that, as shown in FIG. 2, the opening 211 in this embodiment is a plurality of openings 211; however, the present invention is not limited to this. As long as all of the plurality of second through holes 131 of the second plate body 13 can be exposed, there is no limitation on the number of the openings 211. According to one embodiment of the present invention, the base 20 of the present invention is made of aluminum alloy for ensuring that the base 20 of the present invention is reusable, resistant to corrosion, and resistant to 100-degree heat, but the material of the base 20 of the present invention is not limited to this embodiment.

As shown in FIG. 2 and FIG. 3, in this embodiment, the at least one clamp 22 is a plurality of steel clips located at the four side edges of the bearing surface 21 for fixing the testing assembly 10 to the base 20. As shown in FIG. 3, the clamp 22 comprises a fixed end 221 and a free end 222, wherein the fixed end 221 can be connected with the bearing surface 21 by screws or other fastening elements. After the testing assembly 10 is placed on the base 20, a technician toggles the free end 222 of the clamp 22 to cause the free end 222 to contact the testing assembly 10; therefore, the testing assembly 10 is fixed in-between the bearing surface 21 and the clamp 22. Furthermore, the testing assembly 10 with various thicknesses can also be fixed in-between the bearing surface 21 and the clamp 22 by the clamp 22 to increase the suitability of the base 20. It is noted that, in this embodiment, the free end 222 of the clamp 22 contacts a surface of the first plate body 11, for example, the top surface, on which no pins 111 are disposed.

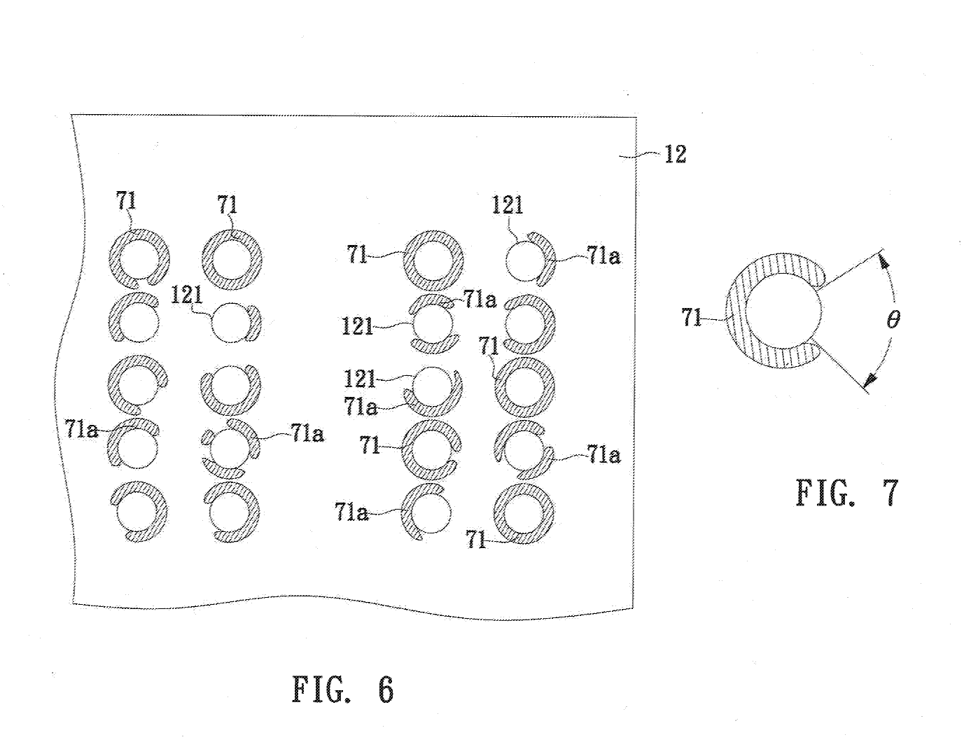

Please refer to FIG. 5, FIG. 6 and FIG. 7, wherein FIG. 6 is a schematic drawing of the wet marks on the testing paper; FIG. 7 is a schematic drawing of the opening angle of the wet marks.

As shown in FIG. 5, in this embodiment, after the testing assembly 10 is assembled and placed on the base 20, the testing apparatus 1 of the present invention moves along a direction indicated by the arrow in FIG. 5. While the testing apparatus 1 is moving, the sprayer 60 sprays the flux 70 underneath the base 20. The flux 70 passes through the opening 211 and coats an inner wall of each second through hole 131, thereby leaving a plurality of wet marks 71 on the testing paper 12, which is located between the first plate body 11 and the second plate body 13, such wet marks 71 corresponding to each second through hole 131 (as shown in FIG. 6) for allowing a technician to interpret the level of the flux 70 coating the inner wall of each second through hole 131.

As shown in FIG. 6, after the flux 70 spraying process has finished, each wet mark 71, 71a on the testing paper 12 is located at the outer edge of each first through hole 121. In this embodiment, the wet marks 71, 71a are in annular shapes and the level of the flux 70 coating the inner wall of each second through hole 131 can be determined by observing the shape of each wet marks 71, 71a, to determine whether the spray coating quality of the flux 70 coating the corresponding inner wall is satisfactory or unsatisfactory.

As shown in FIG. 6 and FIG. 7, the quality of a flux coating of the inner wall of the second through hole 131 corresponding to a wet mark 71 meets manufacturing criteria, or the quality of a flux coating is satisfactory, when o wet mark 71 on the testing paper 12 is in a closed annular shape, or when there is an opening angle θ in the annular shape of the wet marks 71 and the opening angle θ is equal to or smaller than 60° or another predetermined angle. Furthermore, when all of the wet marks 71 on the testing paper 12 are interpreted as indicating that the flux 70 coating each corresponding inner wall of the second through holes 131 meets manufacturing criteria, then there is no need to adjust the sprayer 60 to change the spraying way or the spraying direction of the flux 70.

As shown in FIG. 6, the quality of a flux coating of the inner wall of the second through hole 131 corresponding to the wet marks 71 fails to meet manufacturing criteria, or the quality of a flux coating is unsatisfactory, when a wet mark 71a on the testing paper 12 comprises an opening angle θ greater than 60° (or greater than another predetermined angle) or more than two (or another predetermined amount) opening angles and at least one of the opening angles θ is greater than 60° (or greater than another predetermined angle). In such a case, there is a need to adjust the sprayer 60 to change the spraying way or the spraying direction of the flux 70 for improving the spray coating quality of the flux 70.

The difference between the present invention and the prior art is that the testing assembly 10 of the present invention has a plurality of pins 111, each of which is located in the corresponding second through hole 131 of the second plate body 13. The connecting state of the testing assembly 10 of the present invention is the same as the connecting state of a PCB through hole in which the pin of an electronic component is accommodated during the welding process. Therefore, the quality of a flux coating of the PCB through hole during the manufacturing process can be represented by the quality of a flux coating of the testing assembly 10. Furthermore, a technician can also get a broad picture of the quality of a flux coating of the various formats of pins 111 located in different aperture sizes by observing the wet marks 71, 71a. Thus, the spraying direction, the spraying way, and the spraying quantity of the flux 70 can be adjusted to the optimum conditions by technicians before the welding process. As a result, the quantity of the flux 70 coated in each PCB through hole will be sufficient and the reliability of the solder joints thereby increased. In addition, a waste of the flux 70 in the prior art caused by ensuring that every PCB through hole was coated with an adequate quantity of flux 70 such that some of the PCB through holes were coated with too much flux 70 is also avoided in the present invention.

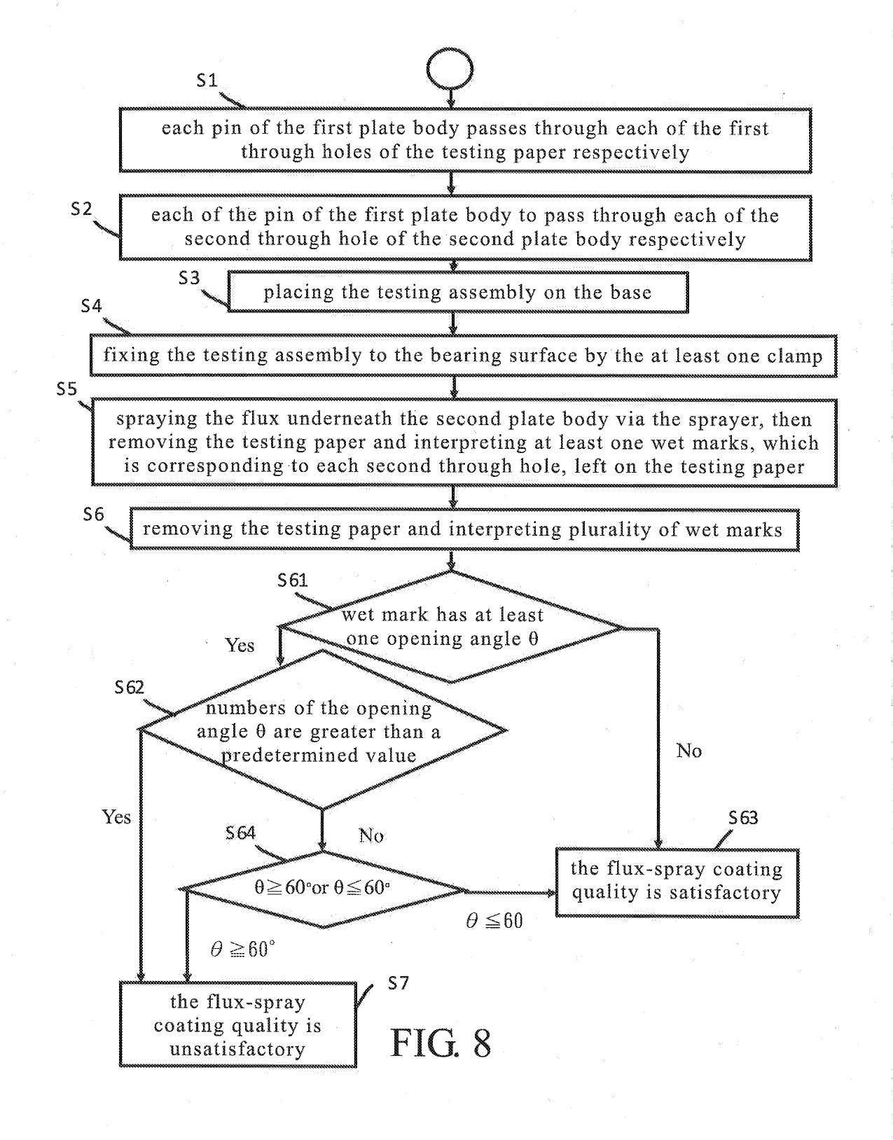

Please refer to FIG. 2, FIG. 7 and FIG. 8 for understanding one embodiment of the testing method of the present invention, wherein FIG. 8 is the flow chart of the testing method of the present invention.

As shown in FIG. 5, the testing method of the present invention is applied for testing the quality of a flux coating of a testing apparatus 1 after a flux 70 has been sprayed thereon via a sprayer 60. As shown in FIG. 2 and FIG. 3, the testing apparatus 1 comprises a testing assembly 10 and a base 20. The testing assembly 10 comprises a first plate body 11, a testing paper 12, and a second plate body 13. The first plate body 11 comprises a plurality of pins 111; the testing paper 12 comprises a plurality of first through holes 121; the second plate body 13 comprises a plurality of second through holes 131 and the first surface 133; the base 20 comprises a bearing surface 21 with at least one opening 211 and at least one clamp 22. As shown in FIG. 8, the testing method of the present invention comprises the following steps:

Step S1: allowing each pin of the first plate body to pass through each of the first through holes of the testing paper respectively.

As shown in FIG. 2, each of the pins 111 of the first plate body 11 passes through the first through hole 121 of the testing paper 12 respectively, wherein the first through holes 121 are set in advance and the locations of the first through holes 121 are corresponding to each of the pins 111. In this embodiment, an adhesive tape is used for fixing the testing paper 12 to the first plate body 11.

Step S2: allowing each of the pins of the first plate body to pass through each of the second through holes of the second plate body respectively.

As shown in FIG. 2, each of the pins 111 of the first plate body 11 passes through each of the corresponding through holes 131 of the second plate body 13, and the testing paper 12 is located between the first plate body 11 and the second plate body 13. As shown in FIG. 4 and FIG. 5, every pin 111 is exposed to the first surface 133 of the second plate body 13 after passing through the second through holes 131.

Step S3: placing the testing assembly on the base.

The testing assembly 10 is placed on the base 20. As shown in FIG. 2 and FIG. 4, in this embodiment, the first surface 133 of the second plate body 13 of the testing assembly 10 contacts the bearing surface 21.

Step S4: fixing the testing assembly to the bearing surface by the at least one clamp.

After the testing assembly 10 is placed on the base 20, the testing assembly 10 is fixed between the bearing surface 21 and the clamp 22 by the clamp 22 of the base 20 (as shown in FIG. 3 and FIG. 4).

Step S5: spraying the flux underneath the second plate body via the sprayer, then removing the testing paper and interpreting at least one wet mark, which corresponds to each second through hole, left on the testing paper.

As shown in FIG. 5, the sprayer 60 sprays the flux 70 underneath the base 20. The flux 70 passes through the opening 211 and then coats the inner wall of each second through hole 131, simultaneously leaving a plurality of wet marks 71 on the testing paper 12, which is between the first plate body 11 and the second plate body 13, corresponding to each second through hole 131 (as shown in FIG. 6) for a technician to interpret the quality of a flux coating on the inner wall of each second through hole 131.

Step S6: removing the testing paper and interpreting the plurality of wet marks.

As shown in FIG. 6, the wet marks 71, 71a on the testing paper 12 are located at the outer edge of each first through hole 12. In this embodiment, the wet marks 71, 71a′ are in annular shapes and a technician can determine the quality of a flux coating of the inner wall of each second through hole 131 through observing the shapes of the wet marks 71, 71a.

Step S61: wet mark has at least one opening angle θ or not.

As shown in FIG. 6, if the wet marks 71a, 71a have at least one opening angle θ, Step S62 is implemented. As shown in FIG. 6, if the wet marks 71, 71a do not have any opening angle θ, Step S63 is implemented.

Step S62: number of the opening angles θ is greater than a predetermined value.

In this embodiment, the predetermined value is one; therefore, if the number of the opening angles θ of the wet marks 71, 71a is more than one, Step S7 is implemented. If the number of opening angles θ of the wet marks 71, 71a is less than one, Step S64 is implemented.

Step S63: the flux-spray coating quality is satisfactory.

As shown in FIG. 6, the flux 70 is evenly coating the inner wall of the second through holes 131, corresponding to the wet mark 71, and the quantity is adequate; i.e., the spray coating quality is satisfactory when there is no opening angle θ in one wet mark 71, or one wet mark 71 has an opening angle θ and the opening angle θ is equal to or smaller than 60°, indicating that the quantity of flux 70 coating the inner wall of second through hole 131 is also sufficient; i.e., the spray coating quality is satisfactory.

Step S64:θ:≧60° or θ≦60°

As shown in FIG. 6, when the opening angle of a wet mark 71 a is greater than 60°, Step S7 is implemented. When the opening angle of a wet mark 71a is smaller than 60°, Step S63 is implemented.

Step S7: the flux-spray coating is unsatisfactory.

As shown in FIG. 6, the flux 70 coating the inner wall of the second through hole 131 corresponding to the wet marks 71a is insufficient when one wet mark 71a has a plurality of opening angles B or one of the opening angles θ is greater than 60°; thus the spray coating quality is unsatisfactory. Therefore, there is a need to adjust the sprayer 60 to change the spraying way or the spraying direction of the flux 70 for improving the spray coating quality of the flux 70.

It is noted that the steps of the testing method of the present invention are not limited to the above-mentioned order. As long as the objects of the present invention can be realized, the steps of the testing method can be changed.

It is noted that the above-mentioned embodiments are only for illustration. It is intended that the present invention cover modifications and variations of this invention provided they fail within the scope of the following claims and their equivalents. Therefore, it will be apparent to those skilled in the art that various modifications and variations can be made to the structure of the present invention without departing from the scope or spirit of the invention.

1. A testing apparatus for testing the quality of a flux coating of the testing apparatus after a flux has been sprayed thereon via a sprayer, the testing apparatus comprising:
a testing assembly comprising:
a first plate body, comprising a plurality of pins;
a testing paper, which is stacked on the first plate body, comprising a plurality of first through holes and each of which is corresponding to each of the pins; and
a second plate body stacked on a surface which is opposite to the surface of the testing paper connected with the first plate body, comprising a plurality of second through holes and each of which is corresponding to each of the first through holes for allowing each pin to pass through each first through hole and each second through hole individually;
whereby after the flux has been sprayed underneath the second plate body via the sprayer, the testing paper is removed and at least one wet mark, which is corresponding to each second through hole, is left on the testing paper for interpretation to confirm the quality of a flux coating of the testing apparatus.

2. The testing apparatus as claimed in claim 1, wherein the second plate body further comprises a first surface, which is opposite to the surface connected with the testing paper, and the plurality of pins are exposed to the first surface after the plurality of pins pass through the plurality of second through holes respectively.

3. The testing apparatus as claimed in claim 1, wherein the plurality of second through holes comprise a plurality of aperture sizes and/or a plurality of formats.

4. The testing apparatus as claimed in claim 1, wherein the testing apparatus further comprises a base for bearing the testing assembly.

5. The testing apparatus as claimed in claim 4, wherein the base comprises a bearing surface and the second plate body further comprises a first surface, which is opposite to the surface connected with the testing paper, wherein the bearing surface contacts the first surface.

6. The testing apparatus as claimed in claim 5, wherein the bearing surface comprises at least one opening for exposing the plurality of second through holes.

7. The testing apparatus as claimed in claim 6, wherein when the sprayer sprays the flux underneath the base, the flux passes through the opening and coats an inner wall, of each second through hole, such that the at least one wet mark is left on the testing paper corresponding to a location of each of the second through holes for interpretation.

8. The testing apparatus as claimed in claim 5, wherein the base comprises at least one clamp and the at least one clamp comprises a fixed end, wherein the fixed end connects with the bearing surface.

9. The testing apparatus as claimed in claim 8, wherein the at least one clamp comprises a free end; when the testing assembly is placed on the base, the free end contacts the first plate body for allowing the testing assembly to be fixed between the bearing surface and the clamp.

10. The testing apparatus as claimed in claim 1, wherein each of the wet marks is located at an outer edge of each first through hole.

11. The testing apparatus as claimed in claim 10, wherein the wet mark is in an annular shape.

12. The testing apparatus as claimed in claim 10, wherein the annular shape is a closed annular shape.

13. The testing apparatus as claimed in claim 10, wherein the annular shape comprises at least one opening angle 0.

14. The testing apparatus as claimed in claim 13, wherein the quality of a flux coating is satisfactory when the at least one opening angle θ is equal to or smaller than 60°.

15. The testing apparatus as claimed in claim 13, wherein the flux-spray coating quality is unsatisfactory when the at least one opening angle θ has a plurality of opening angles θ or the at least one opening angle θ is greater than or equal to 60°.

16. A testing method for testing the quality of a flux coating of the testing apparatus after a flux has been sprayed thereon via a sprayer, wherein the testing apparatus comprises a testing assembly, which comprises a first plate body, a testing paper, and a second plate body, all of which are stacked one above another; the first plate body comprises a plurality of pins; the testing paper comprises a plurality of first through holes, each of which corresponds to a pin; the second plate body comprising a plurality of second through holes, each of which corresponds to a first through hole; the testing method, comprising the following steps:
allowing each pin of the first plate body to pass through each of the first through holes of the testing paper respectively;
allowing each of the pins of the first plate body to pass through each of the second through holes of the second plate body respectively; and
spraying the flux underneath the second plate body via the sprayer, then removing the testing paper and interpreting the at least one wet marks, which are corresponding to each second through hole, left on the Jesting paper to confirm the flux-spray coating quality of the testing apparatus.

17. The testing method as claimed in claim 16, wherein the testing apparatus further comprises a base which comprises a bearing surface and at least one clamp; the testing method further comprises the following steps before the sprayer sprays the flux beneath the second plate body:
placing the testing assembly on the base; and
fixing the testing assembly to the bearing surface by the at least one clamp.

18. The testing method as claimed in claim 17, wherein the bearing surface comprises at least one opening for exposing the plurality of second through holes, the testing method further comprising:
the sprayer spraying the flux underneath the base for allowing the flux to coat an inner wall of each of the second through holes of the second plate body.

19. The testing method as claimed in claim 16, wherein the at least one wet mark is in an annular shape and the testing method for interpreting the at least one wet mark further comprises the following steps:
the flux-spray coating quality is satisfactory when the annular shape comprises at least one opening angle θ and the at least one opening angle 0 is equal to or smaller than 60°; and
the flux-spray coating quality is unsatisfactory when the at least one opening angle θ≧60° is greater than or equal to 60°.
